(19) United States
(12) Patent Application Publication
(10) Pub. No.: US 2014/0068512 A1
(43) Pub. Date: Mar. 6, 2014

(54) SYSTEMS AND METHODS FOR MANAGING DATA TIERS ON A USER INTERFACE

(71) Applicant: salesforce.com, inc., San Francisco, CA (US)

(72) Inventors: Nelson Wong, San Francisco, CA (US); Daniel Wong, San Francisco, CA (US)

(73) Assignee: salesforce.com, inc., San Francisco, CA (US)

(21) Appl. No.: 13/959,326

(22) Filed: Aug. 5, 2013

Related U.S. Application Data
(60) Provisional application No. 61/696,574, filed on Sep. 4, 2012.

(51) Int. Cl. G06F 3/0482

(52) U.S. Cl. CPC G06F 3/0482
USPC 715/810

(57) ABSTRACT

A computer-implemented method executable by a multi-tenant server system for managing data tiers on user interfaces (UIs). The method includes presenting, at a first user session, a first UI displaying a first application button and a second application button; recording the selection by a user of the first application button; displaying a second UI, in response to the selection by the user of the first application button, the second UI including first and second function buttons within the first application; recording the selection by the user of the first function button within the first application; and displaying, at a second user session, a third UI with the first application opened and displaying the first function button in a first, visible tier.

### CROSS-REFERENCE TO RELATED APPLICATION

This application claims the benefit of U.S. provisional patent application Ser. No. 61/696,574 filed Sep. 4, 2012, which is hereby incorporated by reference in its entirety.

### TECHNICAL FIELD

Embodiments of the subject matter described herein relate generally to methods and systems for organizing available user options in a user interface. More particularly, embodiments of the subject matter relate to methods and systems for dividing the user interface of an application into multiple display tiers representing different levels of priority of availability for the various options and virtual buttons presented to the user.

### BACKGROUND

Modern software development is evolving away from the client-server model toward network-based processing systems that provide access to data and services via the Internet or other networks. In contrast to traditional systems that host networked applications on dedicated server hardware, a “cloud” computing model allows applications to be provided over the network “as a service” supplied by an infrastructure provider. The infrastructure provider typically abstracts the underlying hardware and other resources used to deliver a customer-developed application so that the customer no longer needs to operate and support dedicated server hardware. The cloud computing model can often provide substantial cost savings to the customer over the life of the application because the customer no longer needs to provide dedicated network infrastructure, electrical and temperature controls, physical security and other logistics in support of dedicated server hardware.

To increase accessibility of the data, various computing systems such as multi-tenant architectures, client-server systems, and even stand-alone computing environments, allow users to interact with applications having a large number of user selectable options, often resulting in unnecessarily cluttered user interfaces. Accordingly, it is desirable to provide methods and systems for managing the available user options in a manner which reduces clutter. Other desirable features and characteristics will become apparent from the subsequent detailed description and the appended claims, taken in conjunction with the accompanying drawings and the foregoing technical field and background.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures, and:

FIG. 1 is a block diagram of an exemplary multi-tenant data processing system having a query system in accordance with various embodiments;

FIG. 2 is a schematic flow diagram of a learning engine for tracking user interaction with a user interface and for reconfiguring the interface over time, based on the tracked user interaction, in accordance with various embodiments;

FIG. 3 is a screen shot showing an exemplary “contacts” page having an initial button configuration in accordance with various embodiments;

FIG. 4 is a screen shot showing the “contacts” page of FIG. 3 having an updated button configuration in accordance with various embodiments; and

FIG. 5 is a flow chart illustrating an exemplary click reduction method using a learning engine in accordance with various embodiments.

### DETAILED DESCRIPTION

The following detailed description is merely exemplary in nature and is not intended to limit the disclosure the application and uses of the disclosure. Furthermore, there is no intention to be bound by any expressed or implied theory presented in the preceding technical field, background, brief summary or the following detailed description. It should be understood that throughout the drawings, corresponding reference numerals indicate like or corresponding parts and features.

The exemplary embodiments presented here relate to selectively displaying a sub-set of available options based on the user's prior history of interaction with the available options, as well as application data. As a result of tuning (adjusting) the user interface (UI) based on history and/or application data, a reconfigured UI including a specific set of display objects may be presented to the user.

The described subject matter can be implemented in the context of any computer-implemented system, such as a software-based system, a database system, a multi-tenant or stand-alone computing environment, or the like. Moreover, the described subject matter can be implemented in connection with two or more separate and distinct computer-implemented systems that cooperate and communicate with one another.

In accordance with exemplary embodiments, a computer based system is provided for facilitating user interaction with an application. Recognizing that many applications include a large number of user options and functions, the present disclosure describes various ways in which the system automatically configures a user's screen (or graphical user interface (GUI))—on an individual by individual basis—based on each individual's viewing behavior and other tracked metrics. One of the key metrics involves identifying those features and options actually used by a user, and organizing subsequent user interfaces to prioritize the previously used options. The application thus redefines, over time, the user interface (GUI) based on prior viewing and interaction behavior for each individual user.

In a typical business, social networking, or other application, the user is presented with an increasing number of options (individually and collectively referred to herein as display objects) including icons, panels, virtual buttons, lists, menus, tabs, links, pop-ups and pull-downs, for retrieving data, performing various actions, and the like. Managing a large number of available options can be unnecessarily cumbersome and distracting, particularly when an individual user may only utilize a small sub-set of the available options. To mitigate the overload problem, the present disclosure tracks and records each user's activity patterns over time, and filters the application content based on historical user activity data. Specifically, only those buttons likely to be needed by a particular user are displayed in a streamlined first tier interface, reserving the remaining buttons for one or more sub-tiers which are hidden from view (or otherwise visually truncated or suppressed) unless and until they are needed.

In accordance with another embodiment, the screen configuration application of the present disclosure continually reconfigures the presentation of the objects displayed on the screen, for example, by dividing the total available options into multiple display tiers defining multiple levels of importance of at least one sub-set of the total number of option available to the user. The contents presented in the first display tier are completely visible to the user, whereas the contents of lower priority display tiers are initially concealed from the user, but can be displayed if summoned by additional user activity.

Those skilled in the art will appreciate that screen “real estate” is a valuable commodity, especially for mobile devices. The present disclosure relieves administrators and users from the burden of pre-configuring each user's screen within an organization. That is, the screens can be pre-configured but need not be because the system will dynamically adapt each screen to what each user needs based on stated preferences (pre-configuration) and by monitoring each user's use. In an embodiment, such as in the context of an enterprise computing system having a large number of users, the default initial condition may be to present a user interface which displays all options to all users. Alternatively, the initial default configuration may display a sub-set of the available buttons in the first tier, based on the subjective judgment of the administrator or based on aggregate user data from similar environments. Thereafter, as user interaction with various applications is logged, the system prioritizes certain virtual buttons to the first tier based on the user's interaction with those buttons. In a further embodiment, a hot key or other user selectable option may be used to escape the reconfigured UI and return to the initial configuration.

In one implementation, a user can place certain data items of a user-interface into the first display tier and view only these selected items during future interactions with the user-interface. Such display classification represents excellent user engagement and content management and creates a seamless user experience for users who work in systems, such as salesforce.com, on mobile and other systems. In another implementation, the application can track relevant data by logging user interactions with the user-interface and further customizing its user-interface based on the collected data, the user defined preferences, or both.

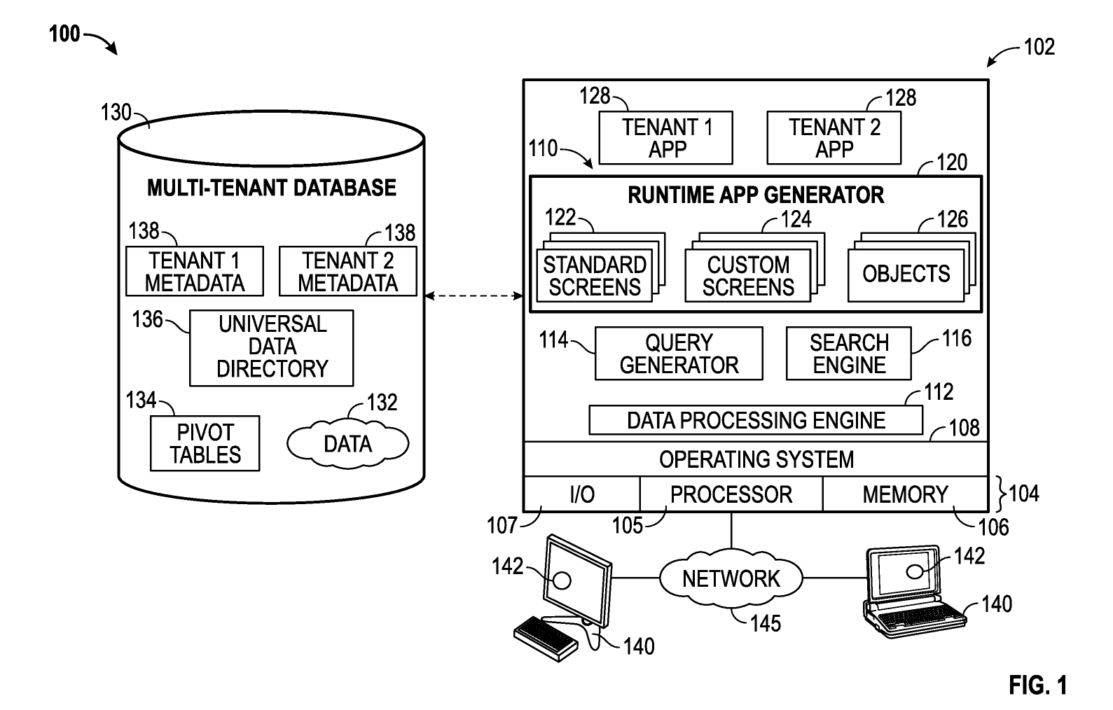

The tools and techniques described herein can be implemented on a variety of computing systems including mobile devices, client-server systems, cloud computing environments, personal computers, laptops, smart appliances, and other electronic and computing devices. One example system is illustrated in FIG. 1. In FIG. 1, an exemplary multi-tenant application system 100 is shown to include a server 102 that is associated with a multi-tenant database 104. In accordance with various non-limiting examples, the system 100 may be implemented in the form of a multi-tenant customer relationship management system that can support any number of authenticated users of multiple tenants. A “tenant” or an “organization” generally refers to a group of users that shares access to common data 106 within the database 104. Tenants may represent customers, customer departments, business or legal organizations, and/or any other entities that maintain data for particular sets of users within the system 100. Although multiple tenants may share access to the server 102 and the database 104, the particular data and services provided from the server 102 to each tenant can be securely isolated from those provided to other tenants. The multi-tenant architecture therefore allows different sets of users to share functionality while managing the sharing of any or none of the data 106.

The server 102, as shown, generally includes any sort of conventional processing hardware 108, such as a processor 110, memory 112, input/output features 114 and the like, that are managed and accessed by a suitable operating system 116. The processor 110 may be implemented using one or more of microprocessors, microcontrollers, processing cores and/or other computing resources spread across any number of distributed or integrated systems, including any number of “cloud-based” or other virtual systems. The memory 112 represents any non-transitory short or long term storage capable of storing programming instructions for execution on the processor 110, including any sort of random access memory (RAM), read only memory (ROM), flash memory, magnetic or optical mass storage, and/or the like. The input/output features 114 represent conventional interfaces to networks (e.g., to a network 118, or any other local area, wide area or other network), mass storage, display devices, data entry devices and/or the like. As can be appreciated, the server 102 may be implemented using a cluster of actual and/or virtual servers operating in conjunction with each other, typically in association with conventional network communications, cluster management, load balancing and other features as appropriate

The server 102 typically includes or cooperates with some type of computer-readable media, where a tangible computer-readable medium has computer-executable instructions stored thereon. The computer-executable instructions, when read and executed by the server 102, cause the server 102 to perform certain tasks, operations, functions, and processes described in more detail herein. In this regard, the memory 112 may represent one suitable implementation of such computer-readable media. Alternatively or additionally, the server 102 could receive and cooperate with computer-readable media (not separately shown) that is realized as a portable or mobile component or platform, e.g., a portable hard drive, a USB flash drive, an optical disc, or the like.

The server 102, as shown, further includes an application platform 120 that may be any sort of software application or other data processing engine that generates virtual applications 122 that provide data and/or services to user devices 124. The virtual applications 122 are typically generated at run-time in response to queries received from the user devices 124. The user devices 124 are typically operated by various tenants that subscribe to the system 100.

For the illustrated embodiment, the application platform 120 includes a bulk data processing engine 126, a query generator 128, a search engine 130 that provides text indexing and other search functionality, and a runtime application generator 132. Each of these features may be implemented as a separate process or other module, and many equivalent embodiments could include different and/or additional features, components or other modules as desired.

The data processing engine 126 performs bulk processing operations on the data 106 such as uploads or downloads, updates, online transaction processing, and/or the like that are requested by the query generator 128, the search engine 130, the virtual applications 122, etc. In various embodiments, less urgent bulk processing of the data 106 can be scheduled to occur as processing resources become available, thereby giving priority to more urgent data processing by the query generator 128, the search engine 130, the virtual applications 122, etc.

The runtime application generator 132 dynamically builds and executes the virtual applications 122 in response to specific requests received from the user devices 124. The virtual applications 122 created by or for the tenants are typically constructed in accordance with the tenant-specific metadata 134, which describes particular tables, reports, interfaces and/or other features of the particular application. In various embodiments, each virtual application 122 generates dynamic web content that can be served to a browser or other client program 136 associated with its user device 124, as appropriate. As used herein, such web content represents one type of resource, data, or information that may be protected or secured using various user authentication procedures.

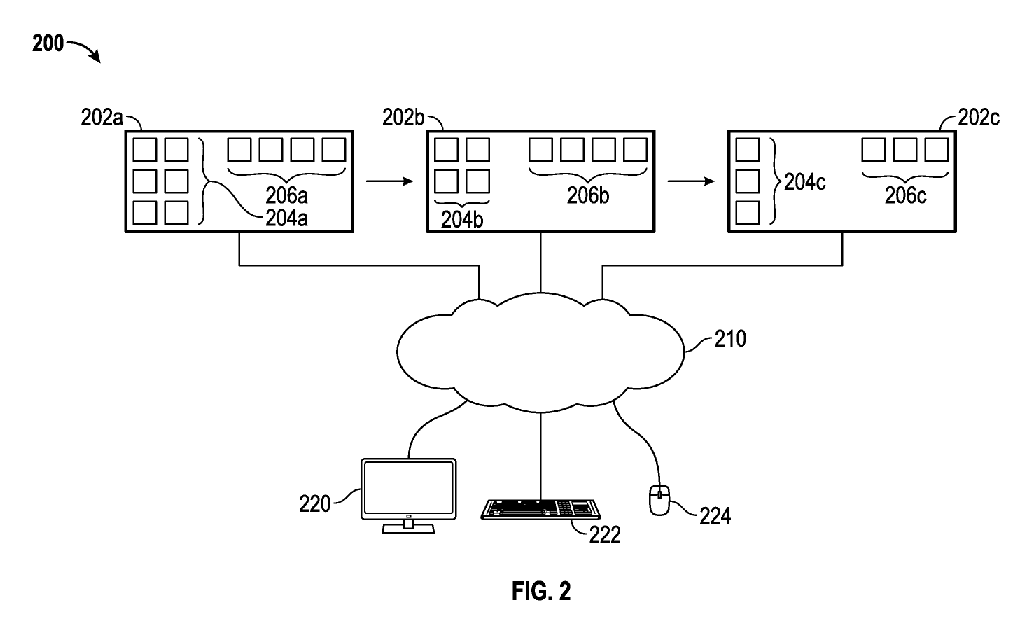

The runtime application generator 132 interacts with the query generator 128 to efficiently obtain multi-tenant data 106 from the database 104 as needed. In various embodiments, the query generator 128 considers the identity of the user requesting a particular function, and then builds and suggests queries to the user. The query generator 128 maintains security of the common database 104 by ensuring that queries are consistent with access privileges granted to a user that initiated the request. The query generator 128 suggests alternate queries based on the initial request while maintaining the security of the common database 104. In various embodiments, the query generator 128 and the processor 110 cooperate in an appropriate manner to perform and manage the various query generation methods described herein in more detail below with reference to FIGS. 2-7.

The database 104 is any sort of repository or other data storage system capable of storing and managing the data 106 associated with any number of tenants. The database 104 may be implemented using any type of conventional database server hardware. In various embodiments, the database 104 shares processing hardware 108 with the server 102. In other embodiments, the database 104 is implemented using separate physical and/or virtual database server hardware that communicates with the server 102 to perform the various functions described herein.

The data 106 may be organized and formatted in any manner to support the application platform 120. In various embodiments, the data 106 is suitably organized into a relatively small number of large data tables to maintain a semi-amorphous “heap”-type format. The data 106 can then be organized as needed for a particular virtual application 122. In various embodiments, conventional data relationships are established using any number of pivot tables 140 that establish indexing, uniqueness, relationships between entities, and/or other aspects of conventional database organization as desired.

Further data manipulation and report formatting is generally performed at runtime using a variety of metadata constructs. The system-wide metadata 138, for example, can be used to describe any number of forms, reports, workflows, user access privileges, business logic and other constructs that are common to multiple tenants. Tenant-specific formatting, functions and other constructs may be maintained as tenant-specific metadata 134 for each tenant, as desired. Rather than forcing the data 106 into an inflexible global structure that is common to all tenants and applications, the database 106 is organized to be relatively amorphous, with the pivot tables 140 and the metadata 134 providing additional structure on an as-needed basis. To that end, the application platform 120 suitably uses the pivot tables 140 and/or the metadata 134 to generate “virtual” components of the virtual applications 122 to logically obtain, process, and present the relatively amorphous data 106 from the database 104.

In operation, developers use the application platform 120 to create data-driven virtual applications 122 for the tenants that they support. Such virtual applications 122 may make use of interface features such as tenant-specific screens 142, universal screens 144 or the like. Any number of tenant-specific and/or universal objects 146 may also be available for integration into tenant-developed virtual applications 122. The data 106 associated with each virtual application 122 is provided to the database 104, as appropriate, and stored until it is requested or is otherwise needed, along with the metadata 134 that describes the particular features (e.g., reports, tables, functions, etc.) of that particular tenant-specific virtual application 122.

The data and services provided by the server 102 can be retrieved using any sort of personal computer, mobile telephone, portable device, tablet computer, or other network-enabled user device 124 that communicates via the network 118. Typically, the user operates a conventional browser or other client program 124 to contact the server 102 via the network 118 using, for example, the hypertext transport protocol (HTTP) or the like. The user typically authenticates his or her identity to the server 102 to obtain a session identifier (“SessionID”) that identifies the user in subsequent communications with the server 102. When the identified user requests access to a virtual application 122, the runtime application generator 132 suitably creates the application at run time based upon the metadata 134, as appropriate.

The query generator 128 suitably obtains the requested data 106 from the database 104 as needed to populate the tables, reports or other features of the particular virtual application 122. As noted above, the virtual application 122 may contain Java, ActiveX, or other content that can be presented using conventional client software running on the user device 124; other embodiments may simply provide dynamic web or other content that can be presented and viewed by the user, as desired.

Turning now to FIG. 2, a flow diagram illustrates an adaptive user interface management system 200 (analogous to application 128) suitable for use in a computer-implemented server system such as the system 100 shown in FIG. 1. This generalized embodiment of the adaptive user interface management system 200 includes a learning engine 200 configured to interact with a user interface (UI) 202 (e.g., a “contacts” page presented by a contacts application) over a period of time.

More particularly, the user interface 202 is depicted as a first user interface 202(a) as it appears at a first time T₁, a second user interface 202(b) as it appears at a second time T₂, and a third user interface 202(c) as it appears at a third time T₃. The first user interface 202(a) includes a navigation panel 204(a) and a function area 206(a); the second user interface 202(b) includes a navigation panel 204(b) and a function area 206(b); and the third user interface 202(c) includes a navigation panel 204(c) and a function area 206(c). A learning engine 210 is suitably configured to track and record, over time, the interaction between the user (not shown) and the user interface 202 via a mobile computing device 220, a keyboard 222, a mouse 224, and any other modality for facilitating interaction between a user and a user interface.

With continued reference to FIG. 2, first UI 202(a) represents an initial or simply an early stage version of the user interface, in which navigation panel 204(a) may include a default configuration of six (6) navigation icons, and function area 206(a) may include four (4) function icons (also referred to herein as options or virtual buttons). As a user interacts with the application over time, the learning engine 210 monitors and records patterns of use, for example, by logging the navigation and function icons used most frequently by each of the various users associated with an enterprise (e.g., tenant). The learning engine 210 may then dynamically reconfigure the UI 202 based on the tracked user interaction (as well as user selected preferences), to produce one or more updated versions 202(b), 202(c) of the UI. Subsequent UI versions may include the same number or fewer items in the navigation panel 204 and function area 206.

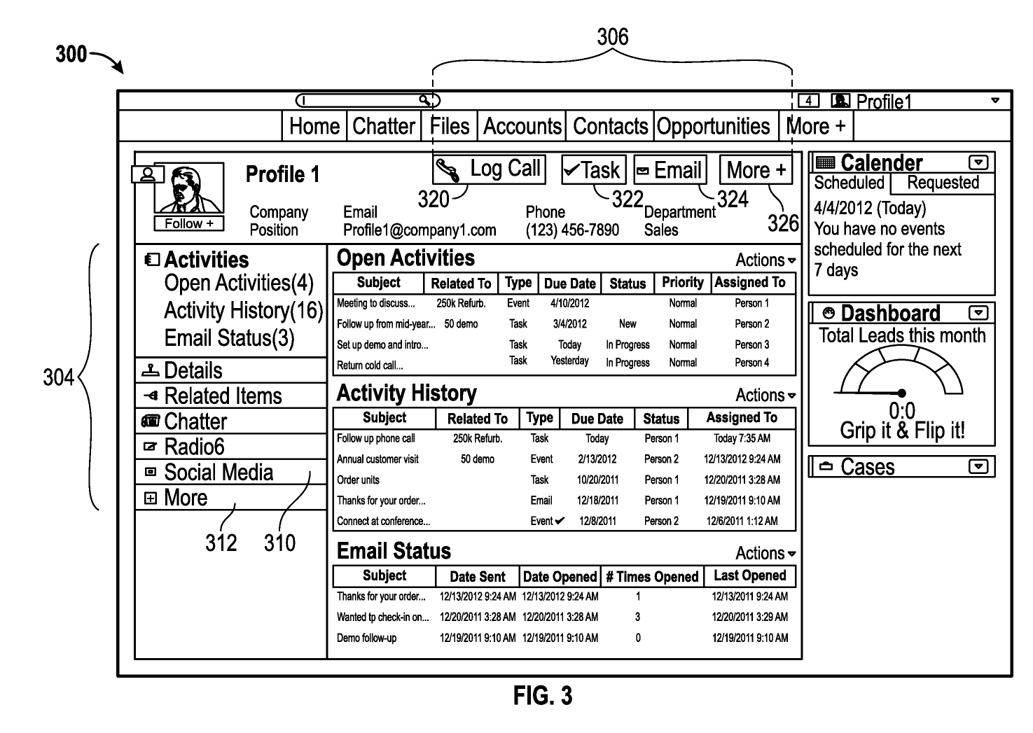

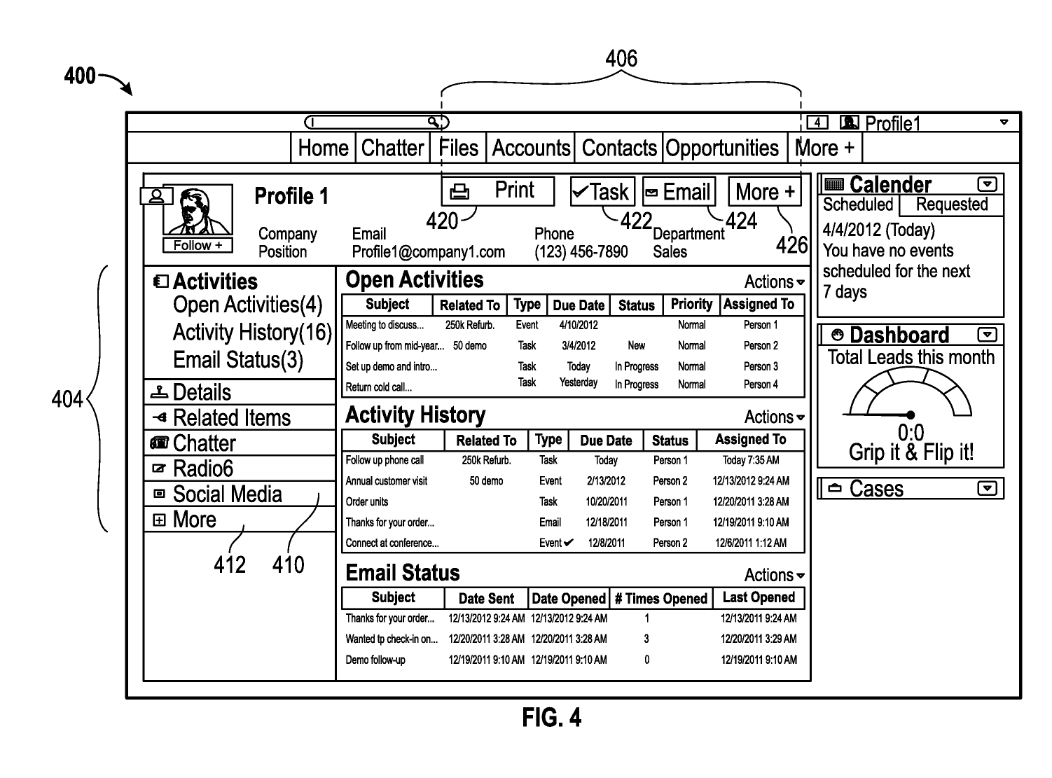

Referring now to FIGS. 3 and 4, FIG. 3 is a screen shot 300 showing an exemplary “contacts” page having an initial button configuration. FIG. 4 is a screen shot 400 showing the “contacts” page of FIG. 3 having an updated button configuration.

More particularly, screen shot 300 is generally analogous to the first user interface 202(a) of FIG. 2, and includes a navigation panel 304 and a function area 306. The navigation panel 304 includes a plurality of navigation options including, for example, a “Linkedin” button 310 and a “more” button 312. The function area 306 includes a plurality of function options including, for example, a “log call” option 320, a “talk” option 322, an “email” option 324, and a “more” option 326.

As a particular user interacts with the UI represented by screen shot 300, the learning engine 210 (FIG. 2) determines which navigation buttons, function buttons, and/or other options are likely to be needed in the future based on past activity, and subsequently presents the user with an updated UI such as shown in FIG. 4.

Referring now to FIG. 4, screen shot 400 is generally analogous to the second or (third) user interface 202(a) (or 202(b)) of FIG. 2, and includes a navigation panel 404 and a function area 406. The navigation panel 404 includes a plurality of navigation options including, for example, a “Twitter” button 410 and “more” button 412. The function area 406 includes a plurality of function options including, for example, a “print” option 420, a “talk” option 422, an “email” option 424, and a “more” option 426. As illustrated, the “Linkedin” navigation button 310 of FIG. 3 has been replaced by the “Twitter” navigation button 410 in FIG. 4. Similarly, the “log out” button 320 in FIG. 3 was replaced by the “Print” button 420 of FIG. 4 based on the tracked user activity.

Stated another way, the first tier navigation panel 404 shown in FIG. 4 includes the “Twitter” button 410 visible to the user, whereas the “Linkedin” button is disposed in the second tier and not visible to the user, but can be accessed by clicking on the “more” button 412. In a similar manner, the first tier navigation panel 406 includes the “print” button 420 visible to the user, whereas the “log call” button is disposed in the second tier—and not visible to the user—but can be accessed by clicking on the “more” button 426.

Various embodiments are described herein in the context of a user's “contacts” page including navigation and function buttons. Those skilled in the art will appreciate, however, that the techniques described herein may be extrapolated or applied to virtually any context or environment such as, for example, a calendar, email, word processing, web-based business and social networking applications (such as workflow and customer relationship management (CRM) applications), and the like, and may include any number or category of icons, applications, virtual buttons, items, options, and the like.

Based on a user's history and access level, the user is thus presented with a first tier that includes options the user has permission to use (access-based) and that the user is likely to use (history-based). In a multi-tenant or “software-as-a-service here” environment, the system administrator typically has ready access to each tenant's operations data (each user's interaction patterns) and each user's privilege and permission levels. Thus, certain subsets of options may be made available to certain groups of users having a corresponding permission level. The various user interface tiers, and particularly the first tier, can be configured based on the foregoing use and permission information and data.

FIGS. 3 and 4 may also be described as illustrating an exemplary user-interface with display tiers based on user-defined criteria and user-activity patterns. In this implementation, the application displays a user's contacts on the application's user-interface based on user-defined criteria such as e-mail status, priority actions, and user-activity patterns such as recently performed actions. Higher priority items are shown in the first tier which is visible to the user. Lower priority options are disposed in one or more subordinate tiers, such as a “show more” or simply “more” button, as described in greater detail below. the theory of operation surrounds the notion that the order in which functions are presented to the user should be prioritized based on the user's activity history, just as navigation buttons and icons should be based on the user's navigation history to thereby make the overall user experience more efficient by reducing the number of button clicks required to perform repetitive actions and tasks.

In yet another implementation, the application can filter data by truncating data items that are outside the scope of the user-defined criteria and/or user-activity pattern. For example, an administrator using an enterprise application connected to a remote on-demand database system to enter sales opportunities in East U.S. region will perform numerous operations on the database. The information associated with the analyst's interaction the database through the user-interface such as groups, contacts, opportunities, and contract type can be tracked and logged by the enterprise application. The application will place relevant data items in the primary display (based on the collected information) and truncate or suppress all other data items.

The example of illustrating the use of technology disclosed herein in an enterprise application should not be taken as limiting or preferred. This example sufficiently illustrates the technology disclosed without being overly complicated. It is not intended to illustrate all of the technologies contemplated, such as the use of display tiers on mobile clients, personalized applications, or applications that are entirely web-based.

In accordance with various embodiments, the system attempts to maintain a consistent look and feel for an application, such as the same number of options, while reconfiguring the particular options based on tracked history of use.

Hence, the technology disclosed herein can provide simplified flow of data that allows merging of multiple data entry points to the same page, thus reducing the number of un-necessary screens for data entry.

In yet another implementation, the user-interface of an application can suggest to the user relevant user-relevant data for future user-activity by automatically generating special templates/shortcuts based on past user-activity.

In yet another implementation, the users of a multi-user application connected to a multi-tenant database can retain ownership to the information related to their activity and prevent its access to other users.

In yet another implementation, the technology disclosed herein can be used to organize page actions and subpage navigation tabs in an application based on user-defined criteria and/or user-activity pattern. The display pages will by default display only those actions and tabs that fall in the user-defined criteria and determined by the user-activity pattern. All other actions and tabs can be hidden from the user and only accessed by extra click actions. These extra actions can be a popup or plug-in menu for action buttons or links, or a “more” link for tabs to subpages.

Accordingly, these implementations can save valuable computation resources that otherwise would render data not relevant to a user and are suited for use with: devices with a small form factor, limited interactive capability, limited display size, limited memory or storage capacity, limited processing power and short battery life; and/or with networks that have/are not consistently available, slow data transfer rates, erratic data transfer services, and no consistent standards; with data having massive quantity and that is not organized for mobile users; with users that have short attention spans, no patience, are on the move, and are routinely in awkward or limited usage situations; and with managers who have security concerns and where applications, devices, and users require a new management layer.

In the context of the present disclosure, a data object is considered to be “interacted” with when it satisfies any desired predetermined and/or configurable interaction criteria. In one embodiment, a data object is interacted with when any record in it is opened; that is, the user “drills down” into the object by opening, clicking on, editing, revising, saving, or otherwise interacting with at least one data record within an object.

The embodiments discussed above are implemented in the context of a multi-tenant environment. Those skilled in the art will appreciate, however, that the structures, methods, and techniques described herein may also be implemented outside the multi-tenant environment, for example, in a stand-alone computing environment

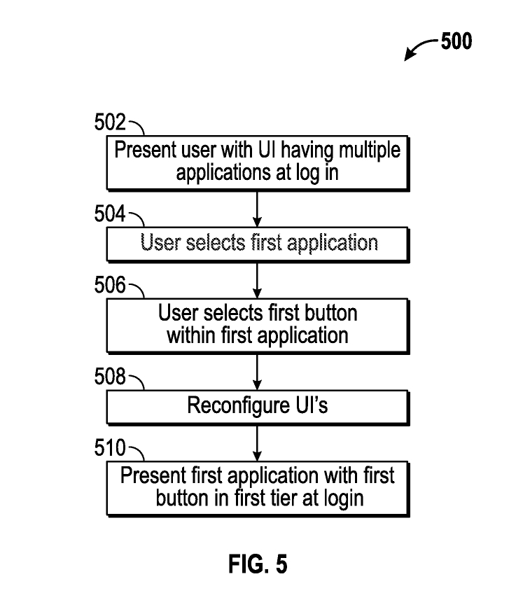

FIG. 5 is a flow chart illustrating an exemplary click reduction method 500 using the learning engine illustrated in FIG. 2. More particularly, the method 500 involves presenting the user with a user interface (UI) which includes multiple applications (functions) at log on (Task 502). The user opens one of the applications (Task 504), and selects a first button within the selected application (Task 506). Based on tracking the user's selections over time, the learning engine reconfigures the UI (Task 508), and subsequently presents the user with a new UI showing the first application with the first button in the first tier at login (Task 510).

A computer-implemented method executable by a multi-tenant server system for managing data tiers on user interfaces (UIs) is provided, the method comprising: presenting, at a first user session, a first UI displaying a first application button and a second application button; recording the selection by a user of the first application button; displaying a second UI, in response to the selection by the user of the first application button, the second UI including first and second function buttons within the first application; recording the selection by the user of the first function button within the first application; and displaying, at a second user session, a third UI with the first application opened and displaying the first function button in a first, visible tier.

The method further includes concealing the second function button in a second, non-visible second tier.

In an embodiment, the first user session comprises a first user logon to the multi-tenant server system, and the second user session comprises a subsequent user logon to the multi-tenant server system.

In another embodiment, displaying the second UI at the second user logon occurs upon detecting the user logging on and without further user action.

In another embodiment, the first UI includes: a first panel comprising the first and second application buttons displayed as a first tier, a first more virtual button; and a second panel comprising the first and second function buttons.

In another embodiment, the first more virtual button corresponds to a second tier of additional application buttons.

In a further embodiment, the first and second function buttons comprise navigation buttons, and the second panel further comprises a second more virtual button corresponding to a second tier of non-visible navigation buttons.

In yet a further embodiment, the method includes reconfiguring the first UI to generate the second UI based on the selection of the first application button and the selection of the first function button.

In another embodiment, the method also includes detecting the selection of the first more virtual button by the user; and displaying, in response to detecting the selection of the first more virtual button, the second tier of additional application buttons.

In another embodiment, the method includes detecting the selection of the second more virtual button by the user; and displaying, in response to detecting the selection of the second more virtual button, the second tier of navigation buttons.

A system is also provided for managing data on a user interface, the system comprising: a processor; and code stored in memory coupled to the processor. The code, when executed on a processor, is configured to: present, at a first user session, a first UI displaying a first application button and a second application button; record the selection by a user of the first application button; display a second UI, in response to the selection by the user of the first application button, the second UI including first and second function buttons within the first application; record the selection by the user of the first function button within the first application; and display, at a second user session, a third UI with the first application opened and displaying the first function button in a first, visible tier.

In an embodiment, the code is further configured to conceal the second function button in a second, non-visible second tier.

In another embodiment, the first user session comprises a first user logon to the multi-tenant server system, and the second user session comprises a subsequent user logon to the multi-tenant server system.

In another embodiment, displaying the second UI at the second user logon occurs upon detecting the user logging on and without further user action.

In a further embodiment, the first UI includes: a first panel comprising the first and second application buttons displayed as a first tier, a first more virtual button; and a second panel comprising the first and second function buttons.

In another embodiment, the first more virtual button corresponds to a second tier of additional application buttons.

In yet a further embodiment, the first and second function buttons comprise navigation buttons, and the second panel further comprises a second more virtual button corresponding to a second tier of non-visible navigation buttons.

In a further embodiment, the code, when executed on the processor, is configured to reconfigure the first UI to generate the second UI based on the selection of the first application button and the selection of the first function button.

In another embodiment, the code is further configured to: detect the selection of the first more virtual button by the user; display, in response to detecting the selection of the first more virtual button, the second tier of additional application buttons; detect the selection of the second more virtual button by the user; and display, in response to detecting the selection of the second more virtual button, the second tier of navigation buttons.

A method is also provided for managing tiers of data buttons on a user interface (UI). The method comprises: selecting data items based upon user-defined criteria and user-activity patterns; dividing the UI into respective first and second display tiers based on the user-activity patterns and permissions; including in the first display tier the highest priority user options; and including in the second tier content initially concealed from the user and accessible upon further user activity.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A computer-implemented method for managing data tiers on user interfaces (UIs), the method comprising:
presenting, at a first user session, a first UI displaying a first application display object and a second application display object;
recording the selection by a user of the first application display object;
displaying a second UI, in response to the selection by the user of the first application display object, the second UI including first and second function display objects within the first application;
recording the selection by the user of the first function display object within the first application; and
displaying, at a second user session, a third UI with the first application opened and displaying the first function display object in a first, visible tier.

2. The method of claim 1 further comprising concealing the second function display object in a second, non-visible second tier.

3. The method of claim 1, wherein the first user session comprises a first user logon to the multi-tenant server system, and the second user session comprises a subsequent user logon to the multi-tenant server system.

4. The method of claim 3, wherein displaying the second UI at the second user logon occurs upon detecting the user logging on and without further user action.

5. The method of claim 2, wherein the first UI includes:
a first panel comprising the first and second application display objects displayed as a first tier, a first more virtual display object; and
a second panel comprising the first and second function display objects.

6. The method of claim 5, wherein the first more virtual display object corresponds to a second tier of additional application display object.

7. The method of claim 5, wherein the first and second function display objects comprise navigation display objects, and the second panel further comprises a second more virtual display object corresponding to a second tier of non-visible navigation display objects.

8. The method of claim 1, further comprising reconfiguring the first UI to generate the second UI based on the selection of the first application display object and the selection of the first function display object.

9. The method of claim 6, further comprising:
detecting the selection of the first more virtual display object by the user; and
displaying, in response to detecting the selection of the first more virtual display object, the second tier of additional application display object.

10. The method of claim 7, further comprising:
detecting the selection of the second more virtual display object by the user; and
displaying, in response to detecting the selection of the second more virtual display object, the second tier of navigation display objects.

11. A system for managing data on a user interface, the system comprising:
a processor;
code stored in memory coupled to the processor; and
the code, when executed on a processor:
presents, at a first user session, a first UI displaying a first application button and a second application button;
records the selection by a user of the first application button;
displays a second UI, in response to the selection by the user of the first application button, the second UI including first and second function buttons within the first application;
records the selection by the user of the first function button within the first application; and
displays, at a second user session, a third UI with the first application opened and displaying the first function button in a first, visible tier.

12. The system of claim 11, wherein the code, when executed on the processor, is further configured to conceal the second function button in a second, non-visible second tier.

13. The system of claim 11, wherein the first user session comprises a first user logon to the multi-tenant server system, and the second user session comprises a subsequent user logon to the multi-tenant server system.

14. The system of claim 13, wherein displaying the second UI at the second user logon occurs upon detecting the user logging on and without further user action.

15. The system of claim 12, wherein the first UI includes:
a first panel comprising the first and second application buttons displayed as a first tier, a first more virtual button; and
a second panel comprising the first and second function buttons.

16. The system of claim 15, wherein the first more virtual button corresponds to a second tier of additional application buttons.

17. The system of claim 16, wherein the first and second function buttons comprise navigation buttons, and the second panel further comprises a second more virtual button corresponding to a second tier of non-visible navigation buttons.

18. The system of claim 11, wherein the code, when executed on the processor, is further configured to reconfigure the first UI to generate the second UI based on the selection of the first application button and the selection of the first function button.

19. The system of claim 17, wherein the code, when executed on the processor, is further configured to:
detect the selection of the first more virtual button by the user;
display, in response to detecting the selection of the first more virtual button, the second tier of additional application buttons;
detect the selection of the second more virtual button by the user; and
display, in response to detecting the selection of the second more virtual button, the second tier of navigation buttons.

20. A method for managing tiers of data buttons on a user interface (UI), the method comprising:
selecting data items based upon user-defined criteria and user-activity patterns;
dividing the UI into respective first and second display tiers based on the user-activity patterns and permissions;
including in the first display tier the highest priority user options; and
including in the second tier content initially concealed from the user and accessible upon further user activity.
